(19) United States
(12) Patent Application Publication
(10) Pub. No.: US 2002/0173569 A1
(43) Pub. Date: Nov. 21, 2002

(54) Drag reducing composition

(76) Inventors: Esa Karhu, Porvoo (FI); Mika Karhu, Porvoo (FI); Leif Rockas, Porvoo (FI); Hannu Harjuhahto, Porvoo (FI)

Correspondence Address: BIRCH STEWART KOLASCH & BIRCH, PO BOX 747, FALLS CHURCH, VA, 22040-0747, US

(21) Appl. No.: 09/959,838

(22) PCT Filed: May 14, 2001
(86) PCT No.: PCT/FI01/00461

(30) Foreign Application Priority Data
May 15, 2000 (FI) 20001153

(51) Int. Cl. C08J 3/00

(52) U.S. Cl. 524/313

(57) ABSTRACT

The invention relates to a concentrated, non-agglomerating, soluble and compatible drag reducing agent composition. It contains (a) from 1 to 60% of a polymer, e.g. non-crystalline and ultrahigh molecular weight poly-α-olefin, capable of reducing drag, and (b) from 40 to 99% of a natural fat or oil, e.g. linseed or rapeseed oil, based on the comined weight of (a) and (b). Preferably, it also contains (c) from 0.1 to 50% of a dispersion stabilising agent, e.g. a fatty acid soap, based on the combined weight of (a), (b) and (c).

### FIELD OF THE INVENTION

The invention relates to a drag reducing agent composition, a process for the preparation of a drag reducing agent composition, and a method for reducing the drag of hydrocarbon flowing.

### PRIOR ART

When a fluid, such as a liquid hydrocarbon, is fed through a conduit, friction resulting from the fluid stream causes a pressure drop increasing with the distance from the point(s) of feeding. Such a friction loss, also called drag, increases the energy and equipment costs required for fluid transportation through the conduit. In order to reduce drag, a variety of polymeric materials have been used as additives in the fluid. Suitable materials have been polymers (=homopolymers and copolymers) of olefins, especially very high molecular weight, non-crystalline and hydrocarbon soluble polymers of C₃-C₃₀ α-olefins. In order to facilitate the storage, transport and feeding of the drag reducing polymeric materials, they have been provided in various forms.

In addition to dry solid polymers, slurries of ground polymers have been used, but they tend to agglomerate with time. Polymer particles coated with an antiagglomerating agent have, on the other hand, limited solubility in the hydrocarbon fluid to be fed. Solutions and gels of polymers demand special equipment for delivery and injection. They are also limited to 10% per weight of polymer as maximum concentration, which is inconvenient.

WO 97/01582 discloses a drag reducing agent composition made by polymerizing an α-olefin in a solvent, adding to the resulting polymer solution a non-solvent which precipitates the polymer as small particles, separating from the resulting slurry supernatant solvent and non-solvent, and reducing the amount of solvent further by adding additional non-solvent and/or evaporating the solvent. The solvents used in this document are typically kerosene, jet fuel, as well as paraffinic and isoparaffinic solvents. Typical non-solvents are C₂-C₆ mono- and polyhydric alcohols, ethers, ketones and esters. Also, anti-agglomeration agents such as metal salts of higher fatty acids may be added in an amount of from 25 to 75% of the weight of the polymer.

WO 98/16586 discloses a drag reducing agent composition which has been made by coating particles of a poly-α-olefin with a non-agglomeration (partitioning) agent which e.g. is a fatty acid wax (monoester), a metal salt of a fatty acid, or a fatty acid amide. Then, the coated poly-α-olefin particles are dispersed in <C₁₄ monohydric alcohols, <C₁₄ glycols as well as polypropylene and polyethylene glycol ethers.

The above technical solutions in which the drag reducing polymer is dispersed in alcohols, ethers, ketones and esters, still have the disadvantage that the dispersion medium is incompatible with the hydrocarbon fluid, the drag of which is to be reduced.

The purpose of the invention is to provide a drag reducing agent composition, which is effective and compatible with the hydrocarbon fluid to be fed through the conduit. Also, the composition should have sufficiently high concentration and be easy to prepare and handle. The raw materials of the composition should be cheap and easily available.

The Present Invention

The objects of the invention have now been accomplished by providing a drag reducing agent composition which primarily is characterized by a dispersion containing:

(a) 1-60% of a polymer capable of reducing drag,

(b) 40-99% of a natural fat or natural oil, both based on the combined weight of (a) and (b).

Preferably, the dispersion also contains:

(c) 0.1-50% of an additive, most preferably a dispersion stabilising agent, based on the weight of (a), (b) and (c).

Adcantageously, components (a), (b) and (c) form at least 80%, most preferably at least about 90% of the weight of the whole drag reducing agent composition. When all three components are present, the above limits become 0.5-59.4% of component (a), 20-98% of component (b) and 0.1-50% of component (c), based on the combined weight of (a), (b) and (c).

By dispersion is meant a system, in which particles of a dispersed phase are not connected but separated from each other by a dispersion medium (Römpps Chemie-Lexicon, 7. Aufl. (1973), 2. Teil, 875).

Detailed Description of the Invention

As stated above, high molecular weight non-crystalline polymers capable of reducing drag are per se well-known in the art, and a skilled person knows how to select them. Preferable polymers are high molecular weight (Mw>3·10⁵ g/mol) C₂-C₃₀ olefin polymers which are essentially non-crystalline, hydrocarbon soluble and capable of reducing hydrocarbon liquid drag. They may be homopolymers or copolymers of said olefins, whereby the comonomer may be another olefin, see EP-A1-0 223 889, page 3, line 38-44, herewith incorporated by reference, or e.g. a divinyl monomer such as divinyl benzene or divinyl siloxane, see U.S. Pat. No. 5,276,116, col. 2, 1. 45,-col. 3, 1. 4, herewith incorporated by reference. Needless to say, a copolymer is a polymer which contains more than one type of repeat unit (Alger, M. S. M., Polymer Science Dictionary, 1990, Elsevier Appl. Sci., page 86), including terpolymers.

Preferably, said polymer is an ultra high molecular weight (UHMW, Mw>3·10⁶ g/mol) non-crystalline C₃-C₃₀ α-olefin polymer, more preferably an UHMW C₄-C₂₀ α-olefin polymer, and most preferably an UHMW C₅-C₁₂ α-olefin polymer. Such polymers are e.g. used in WO 97/01582, herewith included by reference, which on page 5, lines 5-12, mentions poly-α-olefins having molecular weights as high as 10·10⁶ g/mol, having commercial names starting with FLO® and being sold by Baker Pipeline Products, a division of Baker Performance chemicals, Inc.

Thus, the poly-α-olefins of the invention are easily selected by a skilled person. They may also easily be prepared, e.g. by the methods of Mack and Mack et al., herewith included by reference. See the examples in columns 11-18 of U.S. Pat. No. 4,415,714, columns 7-10 of U.S. Pat. No. 4,358,572 and column 4 of U.S. Pat. No. 4,289,679, in which α-olefins are polymerized in the presence of a Ziegler-Natta system comprising titanium chloride, an electron donor, and an alkyl aluminium cocatalyst and the polymerization is stopped at below about 20% conversion. Such polymers are soluble in hydrocarbon fluids and act as drag reducing agents.

Typical α-olefin homopolymers are polybutene-1, polyhexene-1, polyoctene-1, polydecene-1, polyhexadecene-1 and polyeicosene-1. Typical α-olefin copolymers are propene-dodecene-1 copolymer, butene-1-dodecene-1 copolymer, butene-1-decene-1 copolymer, hexene-1-dodecene-1-copolymer, octene-1-tetradecene-1 copolymer, butene-1-decene-1-dodecene-1 copolymer, propene-hexene-1-dodecene-1-copolymer, etc. Preferred polymers are polyhexene-1, polyoctene-1, polydecene-1, polydodecene-1, polytetradecene-1, propene-dodecene-1 copolymer, butene-1-decene-1 copolymer, butene-1-dodecene-1 copolymer and hexene-1-dodecene-1 copolymer. Especially preferred are polyhexene-1 and polyoctene-1.

In addition to the polymer acting as a drag reducing agent for the hydrocarbon fluids, the claimed composition contains a natural fat or natural oil. Preferably, it contains a fatty oil. A fat or fatty oil which can be selected is a solid, semi-solid or liquid product of a plant or an animal which chemically consists essentially of a mixture of glycerin esters of higher fatty acids which have an even number of carbon atoms (Römpps Chemie-Lexicon, 7. Aufl. (1973), 2. Teil, 1101). Naturally, single glycerin esters and synthetic glycerin ester mixtures can also be selected for the invention. Corresponding synthetic fats or fatty oils are also within the claimed scope of protection.

In thet art, the natural fats and natural fatty oils are subdivided according to the dominant individual fatty acid. Thus, fats which may be used in the invention are lauric acid-myristic acid fats like coconut fat, palmitic acid fats like palm fat and stearic acid fats like cocoa butter. However, the fats only melt at temperatures between 24 and 47° C., so, for dispersion, injection and distribution into the hydrocarbon fluid, they have to be heated.

Therefore, the fatty oils are preferred to the fats. Typical fatty oils are the palmitic acid oils such as palm oil the oleic acid-linoleic acid oils such as olive oil, the linolenic acid oils such as linseed oil, perilla oil and hemp oil, and the eruca acid oils such as rapeseed oil and mustard oil. Preferred oils are those based on or containing essential amounts of lauric acid, palmitic acid, stearic acid, oleic acid, linoleic acid and/or myristic acid. Such oils are caybean oil, sun flower oil, lineseed oil, perilla oil, hemp oil rapeseed oil and mustard oil, and the most preferable are lineseed oil and rapaseed oil. Also other oils such as tall oil, based on fatty acids and resin acids such as abietic acid, can be selected for the invention. For fats and oils which can be selected for the invention, see also Ullmanns Encyclopäidie der Technischen Chemie, 3. Aufl., 7. Band, pages 477-482, herewith incorporated by reference.

Although the polymer can be dispersed in the fat or oil only mechanically, the addition of a dispersion stabilising agent is preferred. Preferable dispersion stabilising agents are dispersion agents such as emulsifiers and other anti-agglomeration agents. For the invention, conventional emulsifiers can easily be be selected which establish the right boundary layer activity between the polymer and the fat or fatty oil. Such emusifiers are given by Ullmanns Encyclopädie der Technischen Chemie, 3. Aufl., 6. Band, page 504-507, herewith incorporated by reference. Other useful anti-agglomeration agents can be selected from non-soap metal (e.g. Zn) salts of fatty acids.

However, preferred emulsifiers are O/W oil/water type anionically active species such as soaps and a soap-like substances. Even more preferred are alkali metal, alkaline earth metal or ammonium soaps of fatty acids having from 12 to 22 carbon atoms. Most preferred are the alkali or alkaline earth metal soaps of the very fatty acid, on which the main component of the fat or fatty oil is based. Such a useful dispersion stabilising agent is e.g. the sodium salt of lineseed or rapeseed oil.

The dispersion of the drag reducing composition of the invention contains, when a dispersion stabilising agent is present, 0.5 to 59.4% of component (a), 20 to 98% of component (b) and 0.1 to 50% of component (c), based on the combined weight of (a), (b) and (c). See above.

Preferably, the amount in said dispersion of said polymer (a) is from 5 to 50% by weight, more preferably from 10 to 40% by weight, most preferably from about 20 to about 30% by weight, based on the combined weight of (a), (b) and (c).

Independently, the amount in said dispersion of said natural fat or natural oil (b) is preferably from 50 to 95% by weight, more preferably from 60 to 90% by weight, most preferably from 70 to 80% by weight, based on the combined weight of (a), (b) and (c).

Further, independently, the amount in said dispersion stabilising agent (c) is preferably from 0.5 to 10% by weight, more preferably from 1 to 5% by weight, most preferably from 2 to 3% by weight, based on the combined weight of (a), (b) and (c).

The claimed composition may also contain other components, which improve its properties.

In addition to the above described drag reducing agent composition, the invention also relates to a process for the preparation of a drag reducing agent composition. According to the prior art, the preparation of useful drag reducing agent compositions has proved all but an easy task. As was mentioned above, the polymer particles tend to agglomerate, have low solubility, or either form too dilute or incompatible compositions.

These problems have now been solved by a process, essentially characterized in that a dispersion is formed from (a) the earlier mentioned 1-60% of the earlier mentioned polymer capable of reducing drag and (b) the earlier mentioned 40-99% of the earlier mentioned fat or fatty oil, both percentages being calculated on the combined weight of (a) and (b).

The dispersion may be formed merely by mechanical means, but it is preferable if a dispersion is formed from (a) said amount of said polymer, (b) said amount of said fat or fatty oil and from (c) the earlier mentioned 0.1-50% of the earlier mentioned additive, preferably dispersion stabilising agent, calculated on the combined weight of (a), (b) and (c).

The polymer (a), fat or fatty oil (b), and dispersion stabilising agent (c) are essentially selected as described above in connection with the description of corresponding components (a), (b) and (c) for he claimed drag reducing agent composition. The same applies for the final amounts of said components.

Advantageously, said polymer is provided in the form of a hydrocarbon gel. For instance, the gel may comprise from 1 to 20% by weight, preferably from about 2 to about 10% by weight of said polymer, the rest being essentially hydrocarbon, containing revidual monomer if present. Typically, the gel is formed when polymerizing an α-olefinhydrocarbon to a conversion, which is below 20%.

Before or during contacting the polymer gel with the natural fat or natural oil, it is preferably disintegrated by feeding it through a disintegrating apparatus, preferably a flaker or the like, the size of the flakes or pellets preferably being between 0.1 and 6.0 mm, most preferably beteween 0.5 and 3.0 mm. A convenient flaker is a gear pump, whereby the gears cut off pieces which then come out in the form of said flakes or pellets. Preferably, the gel is fed on the suction side of a circulation gear pump in an apparatus for the dispersion of the components, whereby said disintegration of the gel takes place simultaneously with the dispersion thereof in said fat or oil (and dispersion stabilising agent).

The claimed process may be carried out with or without precontacting the disintegrated gel with a fat or fatty oil.

According to one embodiment of the invention, said polymer is at least once precontacted with and separated from a natural fat or natural oil before it is finally dispersed in said natural fat or natural oil. Preferably, the precontacting fat or oil is the same fat or oil as the one in which the polymer is finally dispersed. The precontacting is advantageously carried out at room temperature, and the precontacting weight ratio between said polymer gel and said fat or oil is preferably between 1:0.5 and 1:10, most preferably between 1:2 and 1:4.

After the precontacting, the polymer is concentrated. The concentration is preferably carried out by separating the polymer from the fat or oil gravimietrically or by centrifuging, with sieves, filters, cyclones, etc., most preferably by vacuum filtration, after which the polymer is dispersed in said fat or oil. The amounts are such as to achieve the above mentioned composition. The dispersion is preferably carried out by means of a dispersion mixer comprising a feed gear pump for feeding the polymer and a circulation gear pump and return pipe for recirculation of the polymer/fat or fatty oil mixture. A typical temperature is 40-150° C., preferably 50-100° C. A typical dispersion time is from 2 to 100 h, preferably from 10 to 50 h.

After precontacting and dispersing the polymer in said fat or fatty oil, unnecessary fat or fatty oil may be removed, preferably by sieving, most preferably by sieving with a 40-100 μm sieve. Then, said dispersion stabilising agent is added. It is preferably added under stirring, more preferably under vigorous stirring, most preferably by means of a homogenization apparatus, e.g. one comprising a geared pump equipped with a check valve and recirculation. Finally, the formed mixture may be stirred for 0.5-10h, preferably for about 2 to about 6 h, e.g. by using a blade mixer at 50-200 rpm.

According to another embodiment of the invention, said polymer is not precontacted, but contacted directly with a mixture of said fat or fatty oil and said dispersion stabilising agent. Then, the polymer is usually dispersed in said fat or oil by mixing at elevated temperature, preferably at 40-150° C., more preferably at 50-100° C., whereby, most preferably, the polymer is in the form of a gel. A final stirring may be carried out as at the end of the precontacting embodiment, see above.

The dispersion stabilising agent is preferably a soap and has more preferably been prepared in situ by reacting said fat or fatty oil with a base of an alkali metal or an alkaline earth metal, most preferably by partially saponifying the fat or fatty oil used as dispersion medium, thus forming a mixture of the fat or fatty oil and the dispersion stabilising agent.

In addition to the claimed drag reducing agent composition and its preparation, the invention also relates to a method for reducing the drag of hydrocarbon flowing. The method is characterized by the steps of:

A. providing a drag reducing agent composition according to the above product description or prepared according to the above process description,

B. feeding the drag reducing agent composition into a conduit in which the hydrocarbon is or will be flowing.

Preferably, the drag reducing agent composition is fed in an amount of about 1-200 ppm, preferably 10-100 ppm, most preferably 20-80 ppm.

The following examples, in which the parts and percentages are on a weight basis. unless otherwise indicated, are merely provided to illustrate the invention.

### EXAMPLES

Measuring Methods

The methods used for characterising the drag reducing agent compositions, henceforth called DRA, can crudely be subdivided into the physical properties (dry matter, viscosity) and the actual performance properties (DPT, DFT, Visko 50). The dry matter of a gel sample is determined by removing the gel solvent(s) by evaporating in a heating chamber. In addition to the polymer, the gel hardly contains other solids, so, the dry matter gives the polymer content of the product. The dry matter of the gel is a remarkable physical property in so far as the performance reached at the site of use depends on the amount of polymer dissolved in the fluid, i.e. when feeding to the fluid equal masses or volumes of different products, most effective agent is fed with the product having the larges dry matter.

The viscosity is the dynamic viscosity (cP) measured by a Brookfield viscometer using different shear rates (e.g. 0.5, 1, 2.5, 5, 10, 20, 50 and 100 rpm).

The DPT (=delta pressure vs. time) is a life span analysis. The sample to be tested is fed to a solvent circulation system maintained by a gear pump. By measuring the outlet pressure, the dissolution of the sample can be followed and thereafter the gradual disappearance of the drag reducing effect can be followed as the sample one time after another passes the pump. In DPT measurements, attention is especially paid to the percent DPT, which is obtained as an integral by summing up the differences between the reference pressure and the momentary pressures during the measurement. The drag reduction can be calculated using the following equation:

% drag reduction=(p₀−pₛ)/p₀×100

wherein p₀ is the measured drop occuring when the test fluid without drag reducing agent was pumped through the test line, and pₛ is the measured pressure drop occuring when the test fluid containing the drag reducing agent was pumperd through the test line.

DFT (=delta force vs. time) is used to measure the efficiency of the DRA in a hydrocarbon solvent, which is vigorously agitated. In the measurement, the registered percentage of drag reduction tells the efficiency of the DRA, which is the better, the larger the % drag reduction. C₀ indicates the amount (in ppm) of DRA which is needed to reach 67% of the maximal efficiency under the conditions of measurement

The Visko 50 test is based on measuring the kinematic viscosity of the sample. A 50 ppm solution of the DRA is prepared, the viscosity of which is compared to the viscosity of pure solvent. The result of a Visko 50 test contains information about the solubility of the DRA as well as its ability to alter the viscoelastic properties of the hydrocarbon fluid. The DRA is considered the better, the larger the Visko 50 value is.

Preparation

1. Apparatus

Apparatus

The dispersion apparatus consisted of a cone bottomed vessel equipped with a heat jacket and a circulation stirrer. The cover of the vessel had a water-cooled column with a connection for the removal of distillate. It also had a separate cooler for the liquidification of effluent gases.

A separate circulation gear pumpand a return pipe were connected to the bottom of the dispersion apparatus.

Another separate feed gear pump was provided for the injection of the polymer gel into the fatty oil (and the dispersion stabilising agent).

A vacuum pump was provided e.g. for filtration between and after the contacting stages.

A homogenizating apparatus of the stator-rotor type was also used having a stepless speed rotation control.

2. Precontacting method

A gel was provided containing 5-10% (see each Example) of polymer. The gel was then added to a fatty oil (rapeseed oil was used in the examples), the weight ratio between said polymer gel and said fatty oil being between between 1:2 and 1:4 (see each Example). The contacting temperature was 20° C. After precontacting, the precontacting gel/fatty oil mixture was transferred onto a vacuum sieve, where the polymer gel particles were separated from the fatty oil.

After the precontacting and the separation, the final amount of fresh fatty oil was added to the separated polymer gel particles in the dispersion apparatus. The amount of gel corresponded to a polymer (dry matter) to fat or fatty oil weight ratio of 1:3-1:9 (see each example). Thereafter, the gel/fatty oil mixture was mixed for 18 h at 70° C.

After the mixing, excess of the fatty oil was removed by filtering, using an 88 μm filter, giving the final amounts of polymer and fatty oil (20-30% of polymer and 70-80% of fatty oil, depending on the Example). After the removal, the final amount (2-3%, depending on the Example) of the dispersion stabilising agent was added and the final mixture was homogenized by a laboratory homogenizator (gear pump/check valve/recirculation). After the homogenization, the dispersion was still stirred with a laboratory stirrer for 4 h.

3. Direct Contacting Method, Including Preparation of Dispersion Stabilising Agent

Suitable amounts of linseed fatty oil and a sodium salt thereof as dispersion stabilising agent (molar ratio e.g. 20:80) are mixed together at room temperature. Alternatively, linseed oil and a 50% NaOH solution are mixed together at about 80° C. to form a linseed oil/sodium salt (soap) mixture having the same molar ratio.

At elevated temperature, possible volatile impurities are allowed to leave by evaporation. Said mixture is kept in the described dispersing apparatus.

Then, the temperature is regulated to about 60° C. and the feed gear pump is started Polymer gel is fed through the feed gear pump and out through a small nozzle into a circulated stream of said mixture of linseed oil and a sodium salt thereof. Feeding takes place on the suction side of a circulation gear pump of the apparatus which then cuts the polymer gel into small pellets of 0.5 to 3.0 mm, which are easily dispersed in the hot mixture. The gel pellets are rapidly heated whereby the hydrocarbon gel solvent is removed by evaporation. The feed of gel is continued until the desired composition (see e.g. the claims) has been reached.

After the dispersion, the product is finally homogenized by means of the above described laboratory homogenizator.

### EXAMPLES

### Example 1 (Precontacting Method)

The preparation of the dispersion was started by feeding 4.5 kg of α-olefin based polymer gel, the polymer content of which was 6.5% by weight into 11 kg of rapeseed oil at room temperature. The resulting gel/oil mixture was vacuum sieved and the treated gel particles were recovered for further treatment. To the polymer gel particles was added 1.8 kg of pure rapeseed oil and the resulting mixture was mixed for 18 h at 70° C. After the mixing, excess rapeseed oil was removed by an 88 μm sieve, and then, 30 g of a sodium salt of rapeseed oil was added as dispersion stabilising agent and the mixture was homogenized with a laboratory homogenizer. Finally, the dispersion was mixed with a blade stirrer for 4 h.

Analysis of the Product

The weight of the polymer/oil mixture after the vacuum filtration was 1.401 kg. The weight of the polymer/oil mixture after the mixing at 70° C. was 1.192 kg. The polymer content of the final dispersion was 24.4%. The DPT value was 31.7%, the DR value was 29.0%, the C₀ value was 5.7, and the Visko 50 value was 0.234.

### Example 2 (Precontacting Method)

The preparation of the dispersion was started by feeding 1.8 kg of α-olefin based polymer gel, the polymer content of which was 6.5% by weight into 5.5 kg of rapeseed oil at room temperature (20° C.). The resulting gel/oil mixture was vacuum sieved and the treated gel particles were recovered for further treatment. To the polymer gel particles was added 0.9 kg of pure rapeseed oil and the resulting mixture was mixed for 18 h at 70° C. Simultaneously, the hydrocarbon present in the gel was removed by evaporation and recovered for reuse. After the mixing, excess rapeseed oil was removed by an 88 μm sieve, and then, 20 g of a sodium salt of rapeseed oil was added as dispersion stabilising agent and the mixture was homogenized for 5 min with a laboratory homogenizer. Finally, the dispersion was mixed with a blade stirrer for 4 h.

Analysis of the Product

The weight of the polymer/oil mixture after the vacuum sieving was 1.031 kg. The weight of the polymer/oil mixture after the mixing at 70° C. was 0.5 kg. The polymer content of the final dispersion was 25.8%. The DPT value was 31.40%, the DR value was 28.7%, the C₀ value was 7.8, and the Visko 50 value was 0.152.

### Example 3 (Direct Contacting Method)

1850 g of linseed oil and 10 g of 50% NaOH solution were fed into the vessel of the dispersion apparatus by means of vacuum. The temperature was raised to 80° C. while mixing. The added compounds were allowed to react for 1 h while maintaining the temperature and the vacuum.

Then, the temperature was regulated to 60° C. and a gear circulation pump was started. The circulation pump circulated the mixture from the vessel through a return pipe back to the vessel. Then, a feeding gear pump was started and 18700 g of the drag reducing polymer gel was slowly fed by it through a 2 mm nozzle onto the suction side of the circulation pump. The circulation pump cut the fed polymer gel into 0.5-3 mm long pieces which were dispersed into the hot mixture of oil and stabilising agent.

After the hydrocarbon solvent evaporation stopped, the dispersion was finally homogenized.

Analysis

The dry matter of the homogenous dispersion was about 24%. The drag reducing properties were tested in a DPT apparatus, and the viscosity was measured from a 50 ppm solution. The DPT value was 34.5%, the DR value was 25.5%, the C₀ value was 7.2, and the visko 50 value was 0.159.

### Example 4

In the preparation of the dispersion, the drag reducing polymer gel Necadd 547® was used. In the polymerization of the polymer, only hexane was used as monomer, and no solvent.

To 100 l of soybean oil 30 l of said Necadd 547® was fed. The feeding of the gel took place by means of a flaking apparatus, in which the gel is contacted with the 20° C. oil stream in the form of small flakes. The oil/gel mixture was transferred directly into a disperser equipped with a steam jacket, in which the mixture was heated to 80° C. and hexene was removed by means of vacuum. The removal of the monomer took 4 h.

After that, the mixture was transferred to a tank. Excess oil wqas removed from the mixture with a vacuum sieve, 200 g of stabilizer ES 2 was added and homogenization was carried out with a laboratory homogenizer (gear pump/check valve/recirculation, homogenizing time 5 min). The mixer was a 100 rpm paddle mixer.

After the vacuum sieving, the weight of the polymer/oil mixture was 3.2 kg. The polymer content of the final dispersion was 25%.

Analysis

The DPT was 32.3%, the DR was 25.0%, the C₀ was 8.0, the Visko 50 was 0.216, the particle size D 50 μm 312, D 90 μm 594 and D 10 μm 86.

1. A drag reducing agent composition, characterized in that it comprises a dispersion containing:
(a) 1-60% of a polymer capable of reducing drag, and
(b) 40-99% of a natural fat or natural oil based on the combined weight of (a) and (b).

2. A composition according to claim 1, characterized in that said natural fat or natural oil is a fatty oil.

3. A composition according to claim 1 or 2, characterized in that said dispersion contains:
(c) 0.1-50% of an additive, preferably a dispersion stabilising agent, based on the combined weight of (a), (b) and (c).

4. A composition according to claim 1, 2 or 3, characterized in that said polymer is a high molecular weight (Mw>3·10⁵ g/mol) C₂-C₃₀ olefin polymer (=homopolymer or copolymer) which is essentially non-crystalline, hydrocarbon soluble.

5. A composition according to claim 4, characterized in that said polymer is an ultra high molecular weight (UHMW, Mw>3·10⁶ g/mol) C₂-C₃₀-α-olefin polymer, preferably an UHMW C₄-C₂₀-α-olefin polymer, most preferably an UHMW C₆-C₁₄α-olefin polymer.

6. A composition according to any preceding claim, characterized in that said natural fat or natural fatty oil is a natural fat or fatty oil, the main component of which is based on lauric acid, palmitic acid, stearic acid, oleic acid, linoleic acid and/or myristic acid.

7. A composition according to claim 6, characterized in that said fatty oil is selected from soybean oil, sunflower oil, lineseed oil, perilla oil, hemp oil, rapeseed oil and mustard oil, and preferably is lineseed or rapeseed oil.

8. A composition according to any of claims 3-7, characterized in that said dispersion stabilising agent is an emulsifying agent, preferably an O/W type anionically active species such as a soap and a soap-like substance.

9. A composition according to claim 8, characterized in that said dispersion stabilising agent is an alkali metal, alkaline earth metal or ammonium soap of a fatty acid having from 12 to 22 carbon atoms, preferably an alkali or alkaline earth metal soap of the fatty acid, on which the main component of the fat or fatty oil is based, most preferably the sodium salt of lineseed or rapeseed oil.

10. A composition according to any preceding claim, characterized in that the amount in said dispersion of said polymer is 5-50% by weight, preferably 10-40% by weight, most preferably about 20-30% by weight.

11. A composition according to any preceding claim, characterized in that the amount in said dispersion of said natural fat or natural oil is 50-95% by weight, preferably 60-90% by weight, most preferably 70-80% by weight.

12. A composition according to any preceding claim, characterized in that the amount in said dispersion of said dispersion stabilising agent is 0.5-10% by weight, preferably 1-5% by weight, most preferably 2-3% by weight.

13. Process for the preparation of a drag reducing agent composition according to any of claims 1-11, characterized in that a dispersion is formed from (a) said 1-60% of said polymer capable of reducing drag and (b) said 40-99% of said natural fat or natural oil, both percentages being calculated on the combined weight of (a) and (b).

14. Process according to claim 12, characterized in that a dispersion is formed from (a) said amount of said polymer, (b) said amount of said fat or fatty oil and from (c) said 0.1-50% of said addive, preferably said dispersion stabilising agent, calculated on the combined weight of (a), (b) and (c).

15. Process according to claim 12 or 13, characterized in that said polymer is provided in the form of a hydrocarbon gel.

16. Process according to claim 14, characterized in that the gel comprises 1-20% by weight, preferably about 2-about 10% by weight of said polymer.

17. Process according to claim 15 or 16, characterized in that said gel has been disintegrated by feeding it through a disintegrating apparatus, preferably a flaker or a gear pump, the size of the flakes preferably being 0.1-6.0 mm, most preferably 0.5-3.0 mm.

18. Process according to claim 17, characterized in that said gel has been desintegrated in or into said natural fat or natural oil.

19. Process according to any of claims 13-18, characterized in that said polymer is at least once recontacted with and separated from a natural fat or natural oil before it is dispersed in said fat or fatty oil.

20. Process according to claim 19, characterized in that the natural fat or natural oil of said precontacting is the same fat or oil, preferably fatty oil, as the one in which the polymer is dispersed.

21. Process according to claim 19 or 20, characterized in that in said polymer gel is precontacted with a stream of natural fat or natural oil, preferably at room temperature.

22. Process according to claim 21, characterized in that in said precontacting, the weight ratio between said polymer gel and said natural fat or natural oil is 1:0.5-1:10, preferably 1:2-1:4.

23. Process according to any of claims 19-22, characterized in that after said precontacting, the polymer dispersion is concentrated.

24. Process according to any of claims 19-23, characterized in that after said precontacting and concentration, the polymer dispersion is redispersed in said natural fat or natural fatty oil.

25. Process according to any of clams 14-24, characterized in that after dispersing the polymer in said natural fat or natural fatty oil, said dispersion stabilising agent is added.

26. Process according to claim, characterized in that said dispersion stabilising agent is added under string, preferably under vigorous stirring, most preferably by means of a homogenization apparatus.

27. Process according to any of claims 13-26, characterized in that after the polymer and the natural fat or natural oil have been contacted and contacted with the dispersion stabilising agent, the formed mixture is stirred for 0.5-10 h, preferably for about 2-6 h.

28. Process according to any of claims 13-17, characterized in that said polymer is contacted with a mixture of said natural fat or natural oil and said dispersion stabilising agent

29. Process according to any of claims 13-28, characterized in that the polymer is dispersed in said natural fat or natural oil by mixing at elevated temperature, preferably at 40-150° C., more preferably at 50-100° C., whereby, most preferably, the polymer is in the form of a gel.

30. Process according to claim 28 or 29, characterized in that the dispersion stabilising agent has been prepared in situ by reacting said natural fat or natural fatty oil with a base of an alkali metal, alkaline earth metal or ammonium, most preferably by partially saponifying the fat or fatty oil, thus forming a mixture of the fat or fatty oil and the dispersion stabilising agent.

31. A method for reducing the drag of hydrocarbon flowing, characterized by
A. providing a drag reducing agent composition according to any of claims 1-12 or prepared according to any of claims 13-30,
B. feeding the drag reducing agent composition into a conduit in which the hydrocarbon is or will be flowing.

32. A method according to claim 31, characterized in that the drug reducing agent composition is fed in an amount of about 1-200 ppm, preferably 10-100 ppm, most preferably 20-80 ppm.
